(19) United States
(12) Patent Application Publication
(10) Pub. No.: US 2003/0212562 A1
(43) Pub. Date: Nov. 13, 2003

(54) Manual barge-in for server-based in-vehicle voice recognition systems

(75) Inventors: Kaushik A. Patel, Troy, MI (US); Timothy J. Morse, Waterford, MI (US)

Correspondence Address: General Motors Corporation, Legal Staff, Mail Code 482-C23-B21, 300 Renaissance Center, P.O. Box 300, Detroit, MI, 48265-3000, US

(73) Assignee: General Motors Corporation

(21) Appl. No.: 10/144,575

(22) Filed: May 13, 2002

(51) Int. Cl. G10L 21/00

(52) U.S. Cl. 704/275

(57) ABSTRACT

The present invention provides a method for controlling wireless data transmission from a telematics service center to a voice recognition system in a mobile vehicle. The telematics service call center transmits data to the mobile vehicle over a connection, and monitors said connection for a predetermined barge-in tone. When the telematics service call center receives the user-initiated barge-in tone, it stops data transmission and may request additional commands from the user.

### FIELD OF THE INVENTION

This invention generally relates to in-vehicle voice recognition systems. More particularly, the present invention relates to the use of a manual barge-in for server-based in-vehicle voice recognition systems.

### BACKGROUND OF THE INVENTION

In recent years there has been a leap in voice recognition technology due in part to the increase in computer processing speeds in combination with the research done in voice data for the cellular phone industry. One arena in which voice recognition has found a particularly strong use is in-vehicle systems.

Study after study has found that talking on a cell phone, reading a map, adjusting a radio, or adjusting climate control decreases driver reaction time significantly. This along with the desire to provide generally increased convenience, especially in higher-end vehicles, has led to a significant market for in-vehicle voice recognition systems to control various utilities.

Commercial services such as the OnStar or Visteon systems already offer such functionality. While significant advancements have been made in voice recognition technology, there are challenges unique to in-vehicle systems that are not easily overcome. The quality of voice signal is hampered by in-vehicle noise, and there are other difficulties relating to attenuation, feedback, and acoustic echo.

Some in-vehicle systems may be considered server-based. In other words, information may be passed over a cellular network to and from a server outside of the vehicle. A fully duplex system is one that includes voice information being passed both to and from the server. In such systems, the user may initiate their ability to speak voice commands through the use of a hotword. A hotword is a specific word that the server may monitor for, and when spoken, the server may cease sending information and await further commands from the user. Sometimes the server may be in the process of sending voice information to the vehicle when the user wishes to make a command, thus requiring an interruption, or barge-in, to override the process the server is currently running to allow the user to issue new commands. Current efforts related to hotword barge-in have only reached seventy percent accuracy in recognition.

Another relatively new and unobtrusive means of allowing a user to interact with in-vehicle systems is through the use of command buttons, often located on the steering wheel. Functionality has been developed to control radio, climate, and phone services using this method. The Visteon system, for example, allows a user to press a button and command an in-vehicle module to, for example, “call mom.” The system responds by dialing out using a cellular phone and thus provides the user with relatively hands-free interaction with that phone system. This system, and other systems to date, have dealt only with in-vehicle modules, and have not adequately addressed server-based voice recognition systems and the associated barge-in requirements.

It would be desirable to provide a method for server-based voice recognition systems that overcomes the above-mentioned disadvantages and allows for better accuracy in receiving barge-in requests.

### BRIEF SUMMARY OF THE INVENTION

One aspect of the invention presents a method for controlling wireless data transmission from a telematics service call center to a voice recognition system in a mobile vehicle. The telematics service call center transmits data to the mobile vehicle over a connection. The telematics service call center then monitors the connection for a predetermined barge-in tone. When the telematics service call center receives a user-initiated barge-in tone, the telematics service call center stops the data transmission in response to said barge-in tone.

Another aspect of the invention presents a computer usable medium including a program for controlling wireless data transmission from a telematics service call center to a voice recognition system in a mobile vehicle. The program transmits data from the telematics service call center to the mobile vehicle over a connection. The program monitors the connection for a predetermined barge-in tone that may be initiated by a user. The program then stops transmitting the data from the telematics service call center in response to the barge-in tone.

Another aspect of the invention presents a system for controlling wireless data transmission from a telematics service call center to a mobile vehicle including means for transmitting data from the telematics service call center to the mobile vehicle over a connection; means for monitoring the connection for a predetermined barge-in tone at the telematics service call center; means for receiving a user-initiated barge-in tone at the telematics service call center; and means for stopping transmission of the data from the telematics service call center in response to the barge-in tone.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram illustrating one embodiment of a mobile vehicle communication system, in accordance with the present invention; and

FIG. 2 is a flowchart representation of one embodiment of a process for controlling wireless data transmissions, in accordance with the present invention.

### DETAILED DESCRIPTION OF THE DRAWINGS

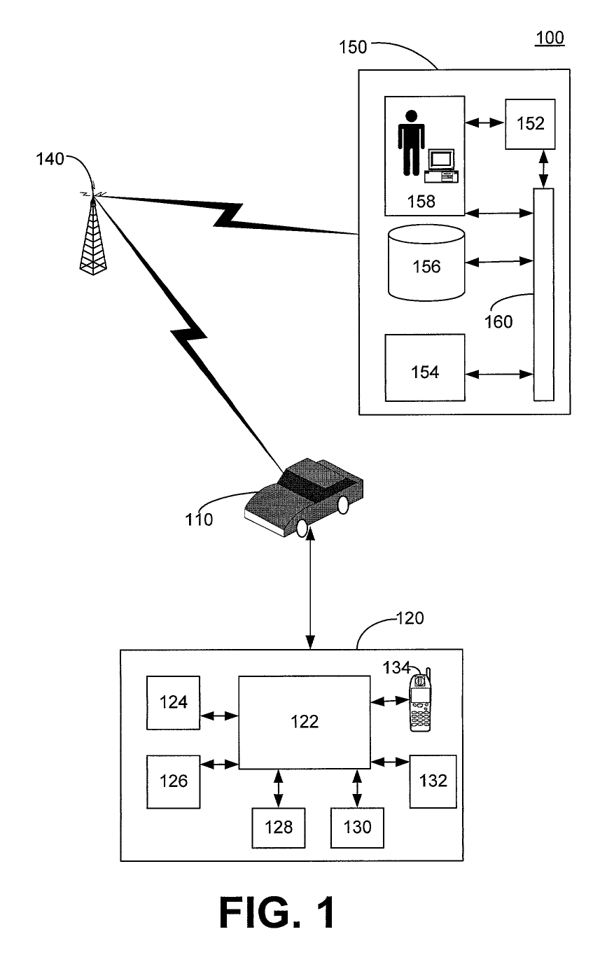

FIG. 1 illustrates one embodiment of a system for controlling wireless data transmissions, in accordance with the present invention, and may be referred to as a mobile vehicle communication system (MVCS) 100. Mobile vehicle communication system (MVCS) 100 may include a mobile vehicle 110, a telematics unit 120, one or more telematics service call centers 150, and a wireless carrier system 140.

Mobile vehicle 110 may be a vehicle equipped with suitable hardware and software for transmitting and receiving voice and data communications. Mobile vehicle 110 contains telematics unit 120. Telematics unit 120 may include a digital signal processor (DSP) 122 connected to a wireless analog, digital or dual-mode modem 124, a global positioning system (GPS) unit 126, an in-vehicle memory 128, a microphone 130, one or more speakers 132, and a network access device (NAD) or in-vehicle mobile phone 134. In-vehicle mobile phone 134 may be an analog, digital, or dual-mode cellular phone.

DSP 122 uses instructions and data from a computer usable medium that may contain various computer programs for controlling programming and operational modes within mobile vehicle 110. Digital signals are used to activate the programming mode and operation modes, as well as provide input and output data.

Telematics service call center 150 is a location where many calls may be received and serviced at the same time, or where many calls may be sent at the same time. The call center prescribes communications to and from mobile vehicle 110. Telematics service call center 150 may be a voice call center, providing verbal communications between an advisor in the call center and a subscriber in a mobile vehicle.

Telematics service call center 150 may contain one or more voice and data switches 152. Switch 152 transmits voice or data transmissions from call center 150. Switch 152 also may receive voice or data transmissions from telematics unit 120 in mobile vehicle 110 through wireless carrier system 140, as is well known in the art. Switch 152 receives and sends data transmissions to and from one or more communication services managers 154 via one or more bus systems 160. Communication services manager 154 is any suitable combination of hardware and software capable of providing requested communication services to telematics unit 120 in mobile vehicle 110. Communication services manager 154 may send to or receive from many different entities including one or more communication services databases 156, one or more communication services advisors 158, all communicating over bus systems 160. Communication services advisor 158 is configured to receive from or send to switch 152 voice or data transmissions.

Wireless carrier system 140 is a wireless communications carrier such as a mobile telephone system. The mobile telephone system may be an analog mobile telephone system operating over a prescribed band nominally at 800 MHz. Alternatively, the mobile telephone system may be a digital mobile telephone system operating over a prescribed band nominally at 800 MHz, 900 MHz, 1900 MHz, or any suitable band capable of carrying mobile communications. Wireless carrier system 140 transmits to and receives signals from mobile vehicle 110. Wireless carrier system 140 may be connected with other communication and landline networks. Telematics service call center 150 may be connected to wireless carrier system 140 with a land-based network, a wireless network, or a combination of landline and wireless networks. In this manner, fully duplex communication is achieved between telematics service call center 150 and mobile vehicle 110.

In one example, mobile vehicle communication system (MVCS) 100 may be implemented as an OnStar system, as is known in the art, with regards to wireless communications between telematics service call center 150 and mobile vehicle 110.

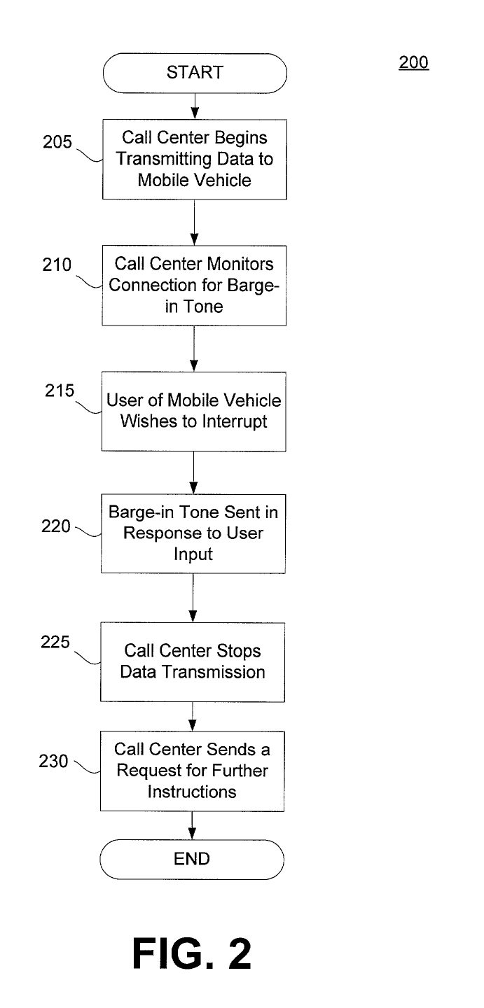

FIG. 2 is a flowchart representation of one embodiment of the process for controlling wireless data transmission, in accordance with the present invention at 200. Telematics service call center 150 transmits information (Block 205) to mobile vehicle 110 over a connection using wireless carrier system 140. This information may be any data or information service provided by telematics service call center 150 such as news, stock information, sports scores, or personal email for the user of mobile vehicle 110. A real or virtual advisor delivers this information from telematics service call center 150 over the one or more speakers 132 to mobile vehicle 110.

During the transmission from telematics service call center 150 to mobile vehicle 110, a user of mobile vehicle 110 may wish to issue a command (Block 215) to telematics service call center 150. To this end, telematics service call center 150 monitors the connection for a barge-in tone (Block 210) issued from mobile vehicle 110. A barge-in tone is any predetermined audio signal that activates an interrupt of the server process at telematics service call center 150. In one embodiment, the barge-in tone may be a Dual Tone Multi Frequency (DTMF) tone. In one embodiment, telematics service call center 150 may monitor for no signal from mobile vehicle 110 other than the barge-in tone.

When the user of mobile vehicle 110 wishes to issue a command, the user executes some manual process to issue the barge-in tone (Block 220), sending it to telematics service call center 150. In one embodiment, the barge-in tone may be issued in response to the user pressing a button. In one embodiment, the button may be situated on the steering wheel of mobile vehicle 110. In another embodiment, the barge-in tone may be issued in response to the user flipping a switch, turning a knob, or any other manual process capable of being processed as a request to send the barge-in tone. In one embodiment, the barge-in tone may be inaudible to the user.

When telematics service call center 150 receives the barge-in tone, it stops its current transmission (Block 225). The barge-in tone is sent to signal that the user of mobile vehicle 110 wishes to halt the current transfer of information. In one embodiment, the barge-in tone signals that the user wishes to issue a voice command via microphone 130 to telematics unit 120. Further to that end, telematics service call center 150, having stopped its current transmission (Block 225), may issue a request for further instructions (Block 230). In one embodiment, the request for further instructions is an audible signal such as a tone, or may be an audible message delivered over the one or more speakers 132. In one embodiment, the alert signal may be a visual cue such as a flashing light, or text display on a dashboard or a heads up display. In this manner, a method is provided for allowing a user of mobile vehicle 110 full barge-in capabilities while overcoming many of the challenges associated with such an activity in server-based in-vehicle voice recognition systems.

The above-described methods and implementation for controlling wireless data transmission from a telematics service call center to a mobile vehicle are example methods and implementations. These methods and implementations illustrate one possible approach for controlling wireless data transmission from a telematics service call center to a mobile vehicle. Moreover, various other improvements and modifications to this invention may occur to those skilled in the art, and those improvements and modifications will fall within the scope of this invention as set forth below.

While embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method for controlling wireless data transmission from a telematics service call center to a voice recognition system in a mobile vehicle, comprising:
transmitting data from the telematics service call center to the mobile vehicle over a connection;
monitoring the connection for a predetermined barge-in tone at the telematics service call center;
receiving a user-initiated barge-in tone at the telematics service call center; and
stopping transmission of the data from the telematics service call center in response to the barge-in tone.

2. The method of claim 1 further comprising:
sending data from the telematics service call center in response to the barge-in tone; and
prompting a user for further input.

3. The method of claim 1 wherein the received barge-in tone is sent in response to a user pressing a button.

4. The method of claim 1 wherein the barge-in tone is not audible in the mobile vehicle.

5. The method of claim 1 wherein the barge-in tone is a DTMF tone.

6. A computer usable medium including a program for controlling wireless data transmission from a telematics service call center to a voice recognition system in a mobile vehicle, comprising:
computer program code to transmit data from the telematics service call center to the mobile vehicle over a connection;
computer program code to monitor the connection for a predetermined barge-in tone at the telematics service call center;
computer program code to receive a user-initiated barge-in tone at the telematics service call center; and
computer program code to stop transmission of the data from the telematics service call center in response to the barge-in tone.

7. The computer usable medium of claim 6 further comprising:
computer program code for sending data from the telematics service call center in response to the barge-in tone; and
prompting a user for further input.

8. The computer usable medium of claim 6 wherein the received barge-in tone is sent in response to a user pressing a button.

9. The computer usable medium of claim 6 wherein the barge-in tone is not audible in the mobile vehicle.

10. The computer usable medium of claim 6 wherein the barge-in tone is a DTMF tone.

11. A system of controlling wireless data transmission from a telematics service call center to a voice recognition system in a mobile vehicle comprising:
means transmitting data from the telematics service call center to the mobile vehicle over a connection;
means for monitoring the connection for a predetermined barge-in tone at the telematics service call center;
means for receiving a user-initiated barge-in tone at the telematics service call center; and
means for stopping transmission of the data from the telematics service call center in response to the barge-in tone.

12. The system of claim 11 further comprising:
means for sending data from the telematics service call center in response to the barge-in tone; and
means for prompting a user for further input.
